(19) United States
(12) Patent Application Publication
(10) Pub. No.: US 2016/0110726 A1
(43) Pub. Date: Apr. 21, 2016

(54) METHOD AND SYSTEM FOR LINKING HANDWRITING TO TRANSACTION DATA

(71) Applicant: MasterCard International Incorporated, Purchase, NY (US)

(72) Inventors: Kenneth UNSER, Fairfield, CT (US); Kent Olof Niklas Berntsson, Rye, NY (US); Jean-Pierre Gerard, Croton-On-Hudson, NY (US)

(73) Assignee: MasterCard International Incorporated, Purchase, NY (US)

(21) Appl. No.: 14/518,565

(22) Filed: Oct. 20, 2014

(51) Int. Cl. G06Q 30/02; G06K 9/00

(52) U.S. Cl. CPC G06Q 30/0201; G06K 9/00181; G06K 9/00194

(57) ABSTRACT

A method for identifying purchase behavior using handwriting characteristics includes: storing, in a handwriting database, a plurality of handwriting profiles, wherein each handwriting profile includes at least a handwriting characteristic and one or more associated purchase behaviors; receiving, by a receiving device, a handwriting sample; analyzing, by a processing device, the received handwriting sample to identify one or more handwriting characteristics; identifying, in the handwriting database, a specific handwriting profile for each of the identified one or more handwriting characteristics, wherein the specific handwriting profile includes the respective handwriting characteristic; and transmitting, by a transmitting device, the one or more associated purchase behaviors included in each of the identified specific handwriting profiles.

### FIELD

The present disclosure relates to the linking of handwriting data to transaction history, specifically the linking of data associated with a signature or handwriting characteristics with consumer payment card transaction history based on a plurality of demographic characteristics and the identification of consumer characteristics based on handwriting characteristics.

### BACKGROUND

Transaction data, which may include any data captured from a payment transaction, may be useful in a variety of situations. Content providers, such as merchants, retailers, third party offer providers, or advertisers may utilize transaction data to identify targeted content, such as offers and advertisements, to distribute to potential consumers. Transaction data may provide valuable insights as to the potential for a specific consumer to redeem an offer or purchase an advertised product, based on their past transactions.

Similarly, handwriting data, which may include various characteristics of handwriting or a signature, may also be valuable to content providers and other third parties. When this type of data is gathered, such as via consumer consent or as provided by an entity (e.g., a merchant for whom the consumer fills out a survey by hand), it may provide this valuable information. A consumer's handwriting style may provide insight as to the personality of the consumer, such as providing insight as to age, gender, attitudes, personality types or traits, etc. However, while such transaction data or handwriting data may be valuable on their own, a combination of the data could provide for even more valuable data points.

Some current systems may be configured to recognize handwriting or to analyze handwriting, while other systems may be configured to store and analyze transaction data. However, there is a technical problem in that these systems are not configured to communicate across the proper channels in order to gather the requisite information, nor are they specially configured to perform analysis to identify correlations between handwriting data, transaction data, and consumer characteristics. Thus, there is a need for a technical solution whereby a system can intelligently link handwriting data to transaction data based on consumer characteristics and analyzed handwriting characteristics.

### SUMMARY

The present disclosure provides a description of systems and methods for linking handwriting data to transaction history, identifying associations between handwriting and purchase behavior, and identifying purchase behavior based on handwriting characteristics.

A method for linking handwriting data to transaction history includes: storing, in a database, a plurality of consumer profiles, wherein each consumer profile includes data related to one or more consumers including at least a plurality of consumer characteristics associated with each of the related one or more consumers and a plurality of transaction data entries each corresponding to a payment transaction involving at least one of the related one or more consumers; receiving, by a receiving device, a handwriting profile, wherein the handwriting profile includes handwriting data associated with one or more specific consumers and a plurality of demographic characteristics associated with each of the one or more specific consumers; identifying, by a processing device, at least one consumer profile of the plurality of consumer profiles where at least a predefined number of the included plurality of consumer characteristics correspond to the plurality of demographic characteristics; and associating, in the database, each of the identified at least one consumer profile with the handwriting data included in the received handwriting profile.

A method for identifying associations between handwriting characteristics and purchase behavior includes: storing, in a handwriting database, a plurality of handwriting profiles, wherein each handwriting profile includes at least a handwriting characteristic; storing, in a profile database, a plurality of consumer profiles, wherein each consumer profile includes data related to one or more consumers including at least a plurality of handwriting characteristics associated with each of the related one or more consumers and a plurality of transaction data entries each corresponding to a payment transaction involving at least one of the related one or more consumers; identifying, for each consumer profile of the plurality of consumer profiles, a plurality of purchase behaviors based on at least the plurality of transaction data entries included in the respective consumer profile; identifying, for a specific handwriting profile in the handwriting database, one or more associated purchase behaviors based on the identified plurality of purchase behaviors included in each consumer profile of the plurality of consumer profiles that includes the handwriting characteristic included in the specific handwriting profile; and associating, in the handwriting database, the identified one or more associated purchase behaviors with the specific handwriting profile.

A method for identifying purchase behavior using handwriting characteristics includes: storing, in a handwriting database, a plurality of handwriting profiles, wherein each handwriting profile includes at least a handwriting characteristic and one or more associated purchase behaviors; receiving, by a receiving device, a handwriting sample; analyzing, by a processing device, the received handwriting sample to identify one or more handwriting characteristics; identifying, in the handwriting database, a specific handwriting profile for each of the identified one or more handwriting characteristics, wherein the specific handwriting profile includes the respective handwriting characteristic; and transmitting, by a transmitting device, the one or more associated purchase behaviors included in each of the identified specific handwriting profiles.

A system for linking handwriting data to transaction history includes a database, a receiving device, and a processing device. The database is configured to store a plurality of consumer profiles, wherein each consumer profile includes data related to one or more consumers including at least a plurality of consumer characteristics associated with each of the related one or more consumers and a plurality of transaction data entries each corresponding to a payment transaction involving at least one of the related one or more consumers. The receiving device is configured to receive a handwriting profile, wherein the handwriting profile includes handwriting data associated with one or more specific consumers and a plurality of demographic characteristics associated with each of the one or more specific consumers. The processing device is configured to: identify at least one consumer profile of the plurality of consumer profiles where at least a predefined number of the included plurality of consumer characteristics correspond to the plurality of demographic characteristics; and associate, in the database, each of the identified at least one consumer profile with the handwriting data included in the received handwriting profile.

A system for identifying associations between handwriting characteristics and purchase behavior includes a handwriting database, a profile database, and a processing device. The handwriting database is configured to store a plurality of handwriting profiles, wherein each handwriting profile includes at least a handwriting characteristic. The profile database is configured to store a plurality of consumer profiles, wherein each consumer profile includes data related to one or more consumers including at least a plurality of handwriting characteristics associated with each of the related one or more consumers and a plurality of transaction data entries each corresponding to a payment transaction involving at least one of the related one or more consumers. The processing device is configured to: identify, for each consumer profile of the plurality of consumer profiles, a plurality of purchase behaviors based on at least the plurality of transaction data entries included in the respective consumer profile; identify, for a specific handwriting profile in the handwriting database, one or more associated purchase behaviors based on the identified plurality of purchase behaviors included in each consumer profile of the plurality of consumer profiles that includes the handwriting characteristic included in the specific handwriting profile; and associate, in the handwriting database, the identified one or more associated purchase behaviors with the specific handwriting profile.

A system for identifying purchase behavior using handwriting characteristics includes a handwriting database, a receiving device, a processing device, and a transmitting device. The handwriting database is configured to store a plurality of handwriting profiles, wherein each handwriting profile includes at least a handwriting characteristic and one or more associated purchase behaviors. The receiving device is configured to receive a handwriting sample. The processing device is configured to: analyze the received handwriting sample to identify one or more handwriting characteristics; and identify, in the handwriting database, a specific handwriting profile for each of the identified one or more handwriting characteristics, wherein the specific handwriting profile includes the respective handwriting characteristic. The transmitting device is configured to transmit the one or more associated purchase behaviors included in each of the identified specific handwriting profiles.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is an illustration of a high level architecture of a system for linking handwriting data and transaction history in accordance with exemplary embodiments.

FIG. 2 is a block diagram illustrating the processing server of FIG. 1 for the linking of handwriting data and transaction history and use thereof in identifying purchase behavior based on handwriting characteristics in accordance with exemplary embodiments.

FIG. 3 is a flow diagram illustrating a method for linking handwriting data with transaction history in a consumer profile in accordance with exemplary embodiments.

FIG. 4 is a diagram illustrating the linking of consumer travel visa data to transaction history in accordance with exemplary embodiments.

FIG. 5 is a diagram illustrating the identification of associations between purchase behavior and handwriting characteristics in accordance with exemplary embodiments.

FIG. 6 is a flow diagram illustrating a process for identifying purchase behaviors based on analyzed handwriting characteristics in accordance with exemplary embodiments.

FIG. 7 is a flow chart illustrating an exemplary method for linking handwriting data to transaction history in accordance with exemplary embodiments.

FIG. 8 is a flow chart illustrating an exemplary method for identifying associations between handwriting characteristics and purchase behavior in accordance with exemplary embodiments.

FIG. 9 is a flow chart illustrating an exemplary method for identifying purchase behavior using handwriting characteristics in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing server 108 does not require possessing any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing server 108 may not possess the PII or be able to decrypt the encrypted PII.

### System for Linking Handwriting Data and Transaction Data

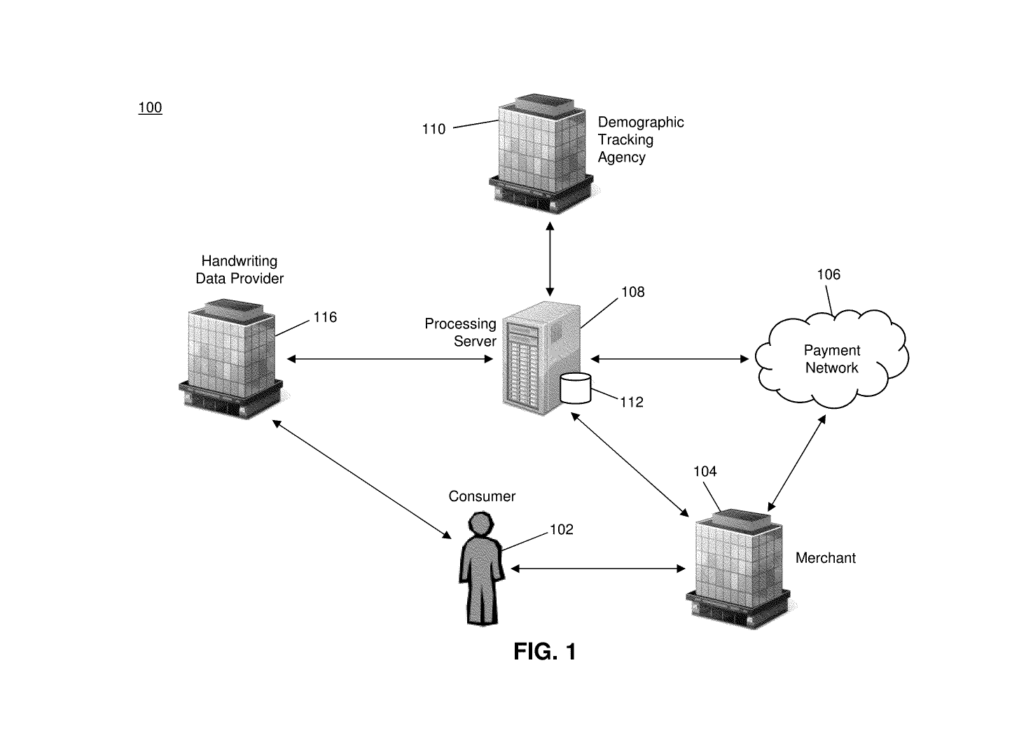

FIG. 1 illustrates a system 100 for linking handwriting data to transaction data and associating handwriting characteristics with purchase behavior based thereon.

A consumer 102 may engage in one or more payment transactions at a merchant 104. The payment transaction or transactions may be conducted in person (e.g., at a physical location of the merchant 104), or remotely, such as via the Internet, telephone, by e-mail or regular mail, text messaging, etc. The transaction may be processed via a payment network 106. The payment network 106 may transmit a copy of the authorization request or transaction data included therein to a processing server 108, discussed in more detail below. The processing server 108 may store the transaction data in a consumer profile of a profile database 112, also discussed in more detail below, associated with the consumer 102. In an exemplary embodiment, the transaction data may only be stored in a consumer profile associated with the particular consumer 102 with the permission of the consumer 102.

The processing server 108 may receive demographic characteristics associated with the consumer 102 from a demographic tracking agency 110 or other third party. The demographic characteristics may include: age, gender, income, marital status, familial status, residential status, occupation, education, zip code, postal code, street address, county, city, state, country, etc. The processing server 108 may store the demographic characteristics in the consumer profile associated with the consumer 102. In an exemplary embodiment, the consumer profile associated with the consumer 102 may not include any personally identifiable information. In some instances, the consumer 102 may be grouped with a plurality of consumers having similar or the same demographic characteristics.

The system 100 may include a handwriting data provider 116. The handwriting data provider 116 may be configured to store handwriting data associated with one or more consumers 102. The handwriting data provider 116 may be, for example, an entity that performs handwriting analysis (e.g., such as the Graphology Consulting Group), merchants 104 or other entities that collect handwriting samples either deliberately or ancillary to another purpose, such as via surveys or contest entries, or any other entity that collects handwriting data that will be apparent to persons having skill in the relevant art.

The handwriting data provider 116 may be configured to furnish stored handwriting data to the processing server 108, which may then store the data in corresponding consumer profiles in the profile database 112. In some embodiments, the handwriting data provider 116 may provide handwriting data to the processing server 108 associated with demographic characteristics corresponding to one or more consumers 102 associated with respective handwriting data. In such an embodiment, the processing server 108 may match the handwriting data to one or more consumer profiles based on the demographic characteristics and the consumer characteristics of the one or more consumer profiles.

The processing server 108 may then have transaction history and handwriting data for a consumer 102 linked together in a consumer profile associated with the consumer 102. In an exemplary embodiment, the consumer profile may not include any personally identifiable information for the consumer 102, except with the express consent of the consumer 102. By linking transaction history with handwriting data, the processing server 108, or a third party, such as an advertiser, that may receive the data from the processing server 108, may be able to obtain significantly more data from a consumer's combined handwriting data and transaction history than utilizing either set of data alone. For instance, transaction history may reveal that a consumer is interested in clothing, while their handwriting data may indicate that they are likely a male, and thus may be more valuable in the advertising of clothing to the consumer.

As discussed in more detail below, handwriting data may be grouped among a plurality of consumers 102 to avoid the use of personally identifiable information. In such an instance, a plurality of consumers 102 having similar consumer characteristics may be grouped together into a single profile. As another example, a profile may include consumers 102 that are male, between the ages of 32 and 35, having an income between $50,000 and $75,000, and living in a specific zip code or other designated geographic area. In such an example, the profile may correspond to a number of consumers, such that the travel visa data included in the profile may correspond to each of the consumers and thus not be personally identifiable to any specific consumer. Additional methods and systems for associating consumers based on consumer characteristics and the grouping of consumers for privacy of the consumers can be found in U.S. patent application Ser. No. 13/437,987, entitled “Protecting Privacy in Audience Creation,” to Curtis Villars et al., filed Apr. 3, 2012, which is herein incorporated by reference in its entirety.

In some embodiments, the processing server 108 may be configured to identify associations between handwriting characteristics and transaction data. In such an embodiment, the handwriting data provider 116 may provide, or the processing server 108 may identify via conventional analysis (e.g., such as disclosed, for example, in U.S. Patent Publication No. 2012/0114246 by Michael Scott Weitzman; U.S. Patent Publication No. 2011/0217679 by Sara Rosenblum; and U.S. Patent Publication No. 2007/0248267 by Ze'ev Bar-av, which are herein incorporated by reference in their entirety) from data provided by the handwriting data provider 116, handwriting characteristics. Handwriting characteristics may include writing zone preference, letter connection, word connection, decrease in letter or stroke size, increase in letter or stroke size, writing slant, letter spacing, word spacing, line spacing, margin, loop size, writing pressure, writing speed, and other characteristics that may be analyzed from handwriting as will be apparent to persons having skill in the relevant art. See, e.g., http://www.handwritinginsights.com/terms.html, herein incorporated by reference.

The processing server 108 may identify associations between the different handwriting characteristics and purchase behavior, such as based on handwriting characteristics associated with consumer profiles in the profile database 112 and the purchase behaviors associated thereof. The processing server 108 may also be configured to identify purchase behaviors for a handwriting sample based on such associations. For example, the merchant 104 may capture a handwriting sample of the consumer 102, such as at a point of sale, via an in-store kiosk, etc. The merchant 104 may provide the sample to the processing server 108, which may analyze the sample to identify characteristics of the handwriting. The processing server 108 can then identify purchase behaviors associated with the handwriting characteristics, and provide the behaviors to the merchant 104, which may then provide offers, discounts, etc. to the consumer 102 based on the purchase behaviors.

Purchase behaviors may include one or more propensities or spending behaviors associated with a plurality of criteria, such as merchants, merchant categories, products, product categories, product brands, manufacturers, etc. For example, purchase behaviors may include the propensity to spend for a particular type of product, at a particular merchant, etc. Purchase behaviors may also include amounts, such as a propensity to spend at least a specific amount of money. Purchase behaviors may also be time related, such as a propensity to spend money on a specific type of product during a predetermined period of time.

The methods and systems discussed herein may result in the processing server 108 providing analysis that is currently unavailable in any existing technical system due to the communication channels and technical features discussed herein. For example, current systems that gather and store transaction data may not be equipped to collect and analyze handwriting samples for handwriting characteristics, let alone identify purchase behaviors from the stored transaction data that are associated with the analyzed characteristics. The result is a technical system that can identify associations and valuable data that may not be produced by existing systems.

### Processing Device

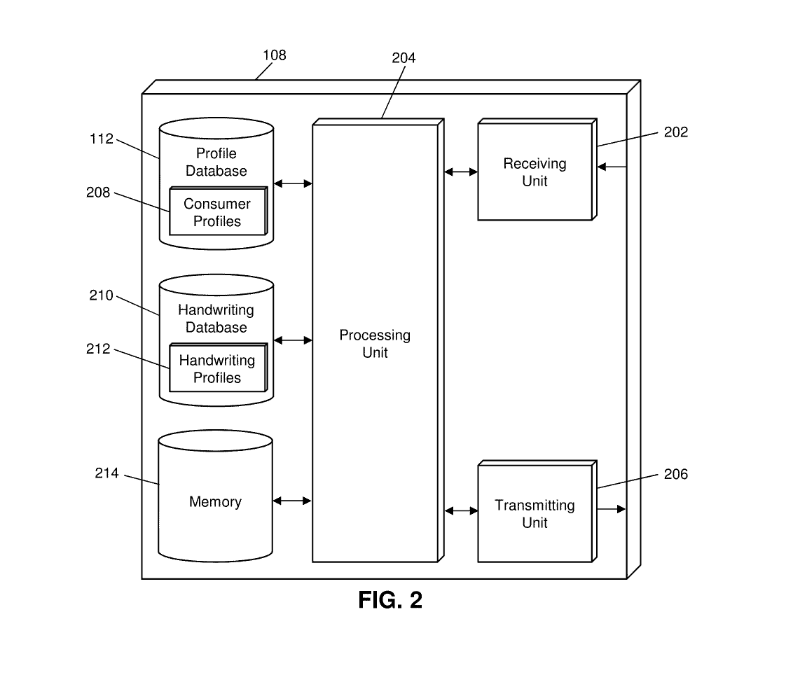

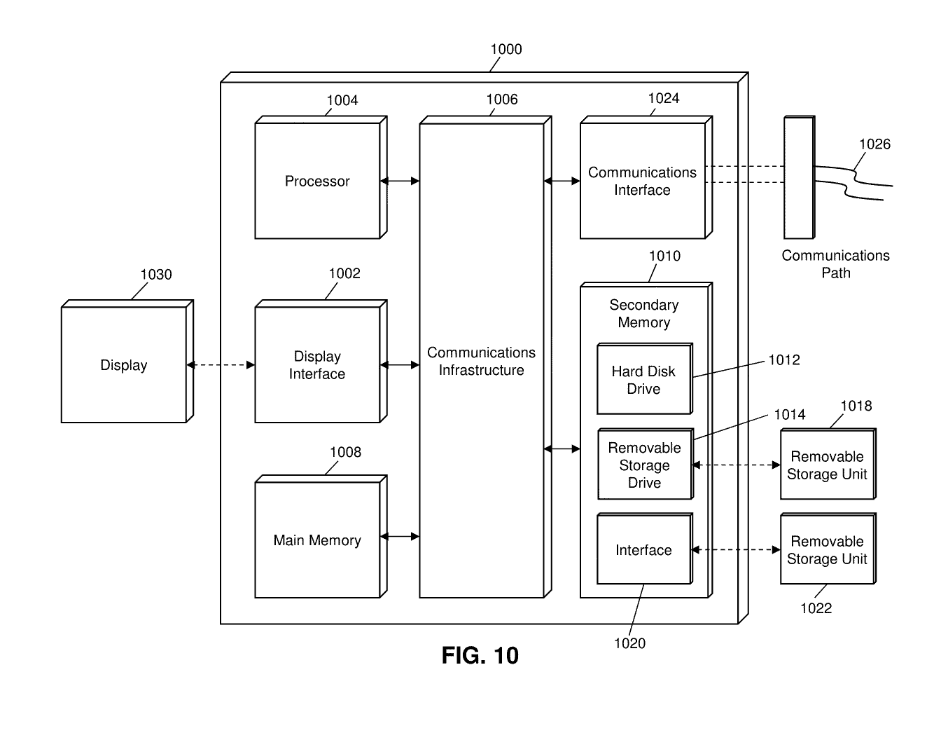

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 1000 illustrated in FIG. 10 and discussed in more detail below may be a suitable configuration of the processing server 108.

The processing server 108 may include a receiving unit 202. The receiving unit 202 may be configured to receive data over one or more networks via one or more network protocols. The receiving unit 202 may be configured to receive transaction data, demographic characteristic data, and handwriting data.

The processing unit 204 may be configured to store a plurality of consumer profiles 208 in the profile database 112. Each consumer profile 208 may include data related to one or more consumers (e.g., consumers 102), including at least a plurality of consumer characteristics and a plurality of transaction data entries for transactions involving one or more of the related one or more consumers. In some embodiments, each consumer profile 208 may also include a plurality of transaction data entries 212. Each transaction data entry may include data related to a corresponding payment transaction, such as a consumer identifier, merchant identifier, transaction amount, transaction time and/or date, geographic location, merchant name, product data, coupon or offer data, a point-of-sale identifier, or other suitable information as will be apparent to persons having skill in the relevant art. In an exemplary embodiment, each consumer profile 208 might not be permitted to include personally identifiable information unless expressly consented to by the corresponding consumer 102. In some embodiments, each consumer profile 208 may be associated with a specific set of consumer characteristics and may accordingly be related to a generic consumer of those characteristics rather than an actual consumer 102. In other embodiments, each consumer profile 208 may be associated with a microsegment of consumers 102.

The processing unit 204 may be configured to link consumer profiles 208 including transaction data entries with handwriting data received by the receiving unit 202. The processing unit 204 may be configured to link the consumer profiles 208 with the handwriting data via demographic characteristics included in the consumer profiles 208 and in the received handwriting data. In some instances, the processing unit 204 may match handwriting data to transaction history based on a predefined number of demographic characteristics (e.g., at least the predefined number of characteristics must match). In other instances, transaction history and handwriting data may be matched via algorithms or other systems and methods that will be apparent to persons having skill in the relevant art. In some embodiments, the processing unit 204 may store the received handwriting data in the linked consumer profile 208.

The processing unit 204 may also be configured to store data in a handwriting database 210. The handwriting database 210 may include a plurality of handwriting profiles 212. Each handwriting profile 212 may include at least a handwriting characteristic. The processing unit 204 may be configured to identify purchase behaviors for each of the handwriting profiles 212. The processing unit 204 may identify the purchase behaviors by analyzing the handwriting data included in each consumer profile 208 for handwriting characteristics and the transaction data included therein for purchase behaviors. The processing unit 204 may then identify purchase behaviors associated with each handwriting characteristic based on the purchase behaviors for each consumer profile 208 associated with the characteristic. The processing unit 204 may store the purchase behaviors in the corresponding handwriting profiles 212.

The processing unit 204 may also be configured to identify purchase behaviors for provided handwriting characteristics. For example, the receiving unit 202 may receive a handwriting sample or handwriting characteristics, such as from a merchant 104. The processing unit 204 may be configured to analyze the handwriting sample to identify one or more handwriting characteristics using methods that will be apparent to persons having skill in the relevant art. The processing unit 204 may then identify handwriting profiles 212 including the identified characteristics, and the purchase behaviors associated therewith.

The processing server 108 may also include a transmitting unit 206. The transmitting unit 206 may be configured to transmit data over one or more networks via one or more network protocols. The transmitting unit 206 may be configured to transmit requests for data, such as to the demographic tracking agency 110 and/or the handwriting data provider 116. The transmitting unit 206 may also be configured to transmit transaction history and/or handwriting data, or a consumer profile 208 including linked transaction history and handwriting data, in response to a request from a third party (e.g., an advertiser). The transmitting unit 206 may also transmit purchase behaviors associated with a provided handwriting sample or characteristic, such as to the merchant 104 in response to a request that includes the provided handwriting sample or characteristic.

The processing server 108 may also include a memory 214. The memory 214 may be configured to store data suitable for performing the functions disclosed herein. For example, the memory 214 may include rules or algorithms for analyzing handwriting characteristics from a handwriting sample, analyzing purchase behaviors from transaction data, identifying common purchase behaviors across multiple consumer profiles 208, and other data that will be apparent to persons having skill in the relevant art.

### Method for Linking Handwriting Data to Transaction History

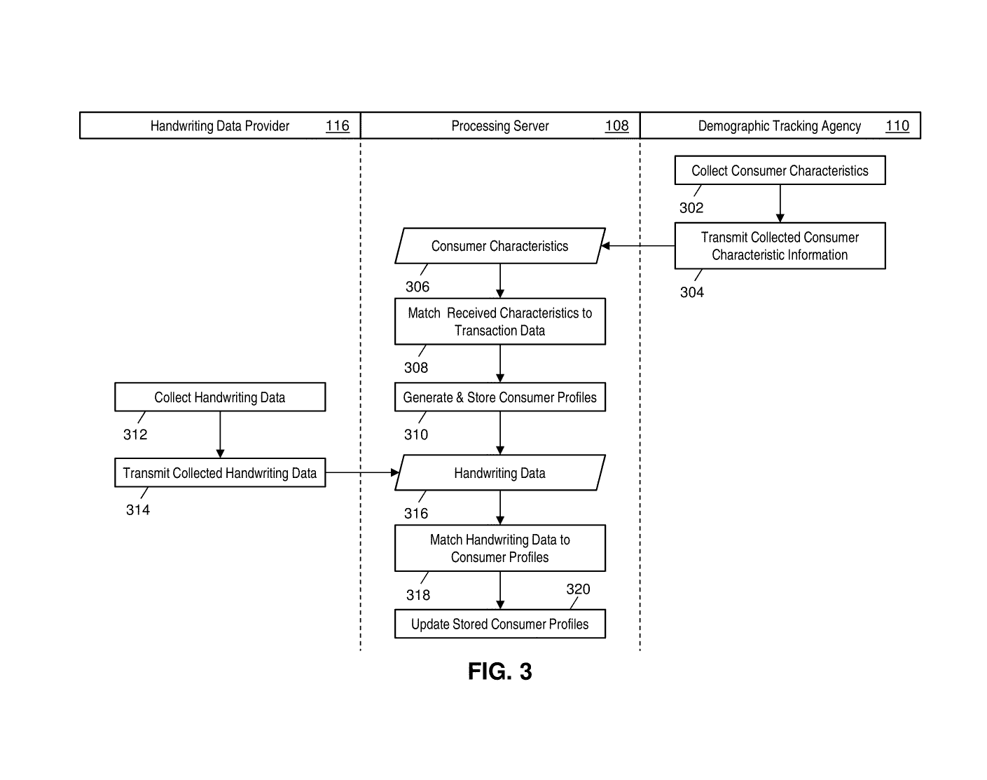

FIG. 3 illustrates a method for linking consumer handwriting data to transaction history.

In step 302, the demographic tracking agency 110 may collect demographic characteristics for one or more consumers. Methods and systems for collecting demographic characteristics will be apparent to persons having skill in the relevant art. The demographic tracking agency 110 may collect the information and may, in step 304, transmit the collected demographic characteristic information to the processing server 108.

In step 306, the processing server 108 may receive the demographic characteristic information. In step 308, the processing unit 204 of the processing server 108 may match the received demographic characteristic information to transaction data entries for processed payment transactions. In step 310, the processing unit 204 may generate consumer profiles 208 for matched transaction history and demographic characteristics (e.g., consumer characteristics) and store the consumer profiles 208 in the profile database 112. In an exemplary embodiment, the processing unit 204 may bucket or otherwise modify the consumer characteristic information and/or transaction data to render the corresponding consumer profile 208 not personally identifiable. In some instances, the processing unit 204 may group transaction data entries for multiple consumers sharing consumer characteristics into a single consumer profile 208.

In step 312, the handwriting data provider 116 may store handwriting profiles for one or more consumers 102, the handwriting profiles including handwriting data and a plurality of demographic characteristics that are associated with the corresponding one or more consumers 102. In step 314, the handwriting data provider 116 may transmit the collected handwriting profile to the processing server 108. The processing server 108 may, in step 316, receive the handwriting profile from the handwriting data provider 116.

In step 318, the processing unit 204 of the processing server 108 may match the received handwriting data to the consumer profiles 208 based on matching of the demographic and consumer characteristics. In step 320, the processing unit 320 may update the consumer profiles 208 to include and/or be associated with the matched handwriting data.

### Linking Handwriting Data to Transaction History

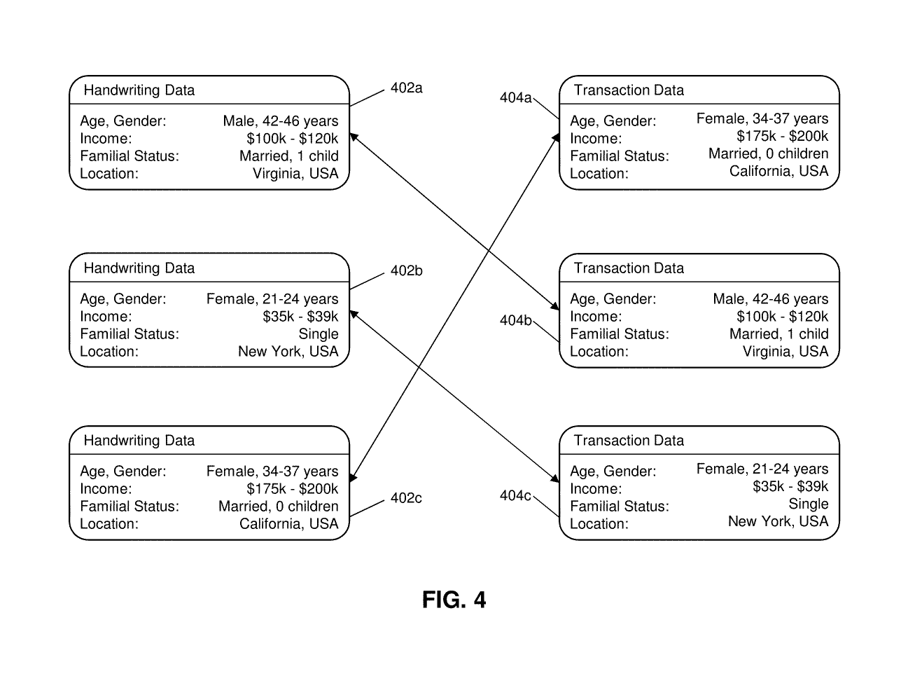

FIG. 4 illustrates the linking of consumer handwriting data 402 to transaction history 604 using demographic characteristics.

Each set of handwriting data 402, illustrated in FIG. 4 as handwriting data 402a, 402b, and 402c, may correspond to a consumer 102 and include a plurality of demographic characteristics. For example, handwriting data 402a corresponds to a consumer 102 that is a male, of an age between 42 and 46 years old, has an income between $100,000 and $120,000, is married, has one child, and lives in Virginia. In some embodiments, the handwriting data 402a may correspond to a plurality of consumers each having the same demographic characteristics data.

Each set of transaction data 404, illustrated in FIG. 4 as transaction data 404a, 404b, and 404c, may correspond to a consumer 102 or a plurality of consumers 102, and include a plurality of consumer characteristics associated with the corresponding consumer or consumers 102. For example, transaction data 404a may correspond to a consumer 102 that is a female, of an age between 34 and 37 years old, has an income between $175,000 and $200,000, is married, has no children, and lives in California.

The processing unit 204 of the processing server 108 may identify the demographic characteristics for each of the handwriting data 402 and transaction data 404 and match the two sets of data based on common demographic and consumer characteristics. For example, in the example illustrated in FIG. 4, the processing unit 204 may match handwriting data 402a with transaction data 404b, handwriting data 402b with transaction data 404c, and handwriting data 402c with transaction data 404a. The processing unit 204 may then store the linked data in one or more consumer profiles 208 including the corresponding consumer characteristics.

In some embodiments, the demographic characteristics for the handwriting data 402 may not directly correspond to the consumer characteristics for the transaction data 404. In such an instance, the processing unit 204 may be configured to link the data based on a predefined number of matching characteristics. For example, if the transaction data 404b was associated with a consumer 102 having two children (instead of one child as illustrated in FIG. 4), while the handwriting data 402a is associated with a consumer 102 having only one child, the processing unit 204 may still link the two sets of data because the sets have at least five matching demographic characteristics including age, gender, income, marital status, and geographic location.

Associating Handwriting Characteristics with Purchase Behavior

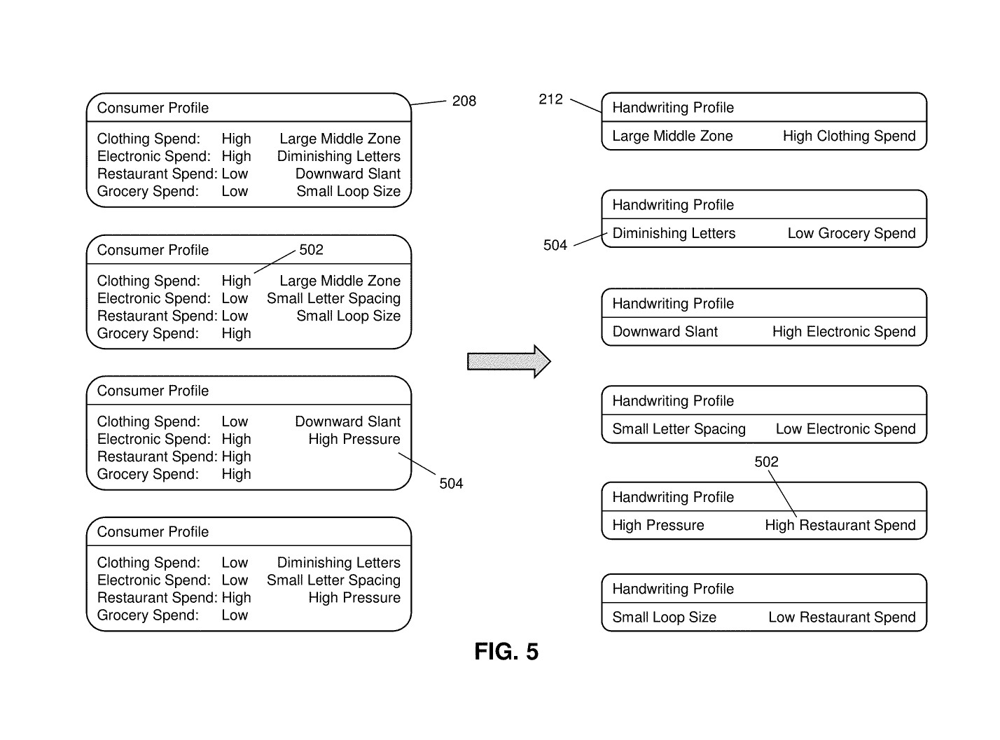

FIG. 5 illustrates the association of handwriting characteristics with purchase behavior.

FIG. 5 includes a plurality of consumer profiles 208. Each consumer profile 208 includes a plurality of purchase behaviors 502. The purchase behaviors 502 may be identified by the processing unit 204 of the processing server 108 based on the transaction data included in the transaction data entries in the respective consumer profile 210. Each consumer profile 208 may also include a plurality of handwriting characteristics 504. The handwriting characteristics 504 may be received from the handwriting data provider 116 and included in the consumer profile 208 based on matching via consumer and demographic characteristics, such as using the method illustrated in FIG. 3 and discussed above.

The processing unit 204 may store a handwriting profile 212 in the handwriting database 210 of the processing server 108 for each of the handwriting characteristics 504 included in the consumer profiles 210. In the example illustrated in FIG. 5, there are six different handwriting profiles 212, with each corresponding to a handwriting characteristic 504 associated with one or more of the consumer profiles 210.

The processing unit 204 may identify each of the consumer profiles 210 that include a given handwriting characteristic 504. The processing unit 204 may then identify one or more purchase behaviors 502 to be associated with the handwriting characteristic 504 based on the purchase behaviors 502 included in each of the identified consumer profiles 210. The resulting purchase behavior 502 may be stored in the respective handwriting profile 212.

In the example illustrated in FIG. 5, the processing unit 204 may identify the large middle zone handwriting characteristic 504 for association with one or more purchase behaviors. The processing unit 204 would identify the two different consumer profiles 210 that include the large middle zone handwriting characteristic 504. In the two consumer profiles 210 that include that handwriting characteristic 504, a high propensity to spend money on clothing is common. As a result, the processing unit 204 determines that having a large middle zone in handwriting is associated with a high propensity to spend on clothing, and stores that respective purchase behavior 502 in the handwriting profile 214 for the large middle zone characteristic 504.

### Process for Identifying Purchase Behaviors Based on Handwriting

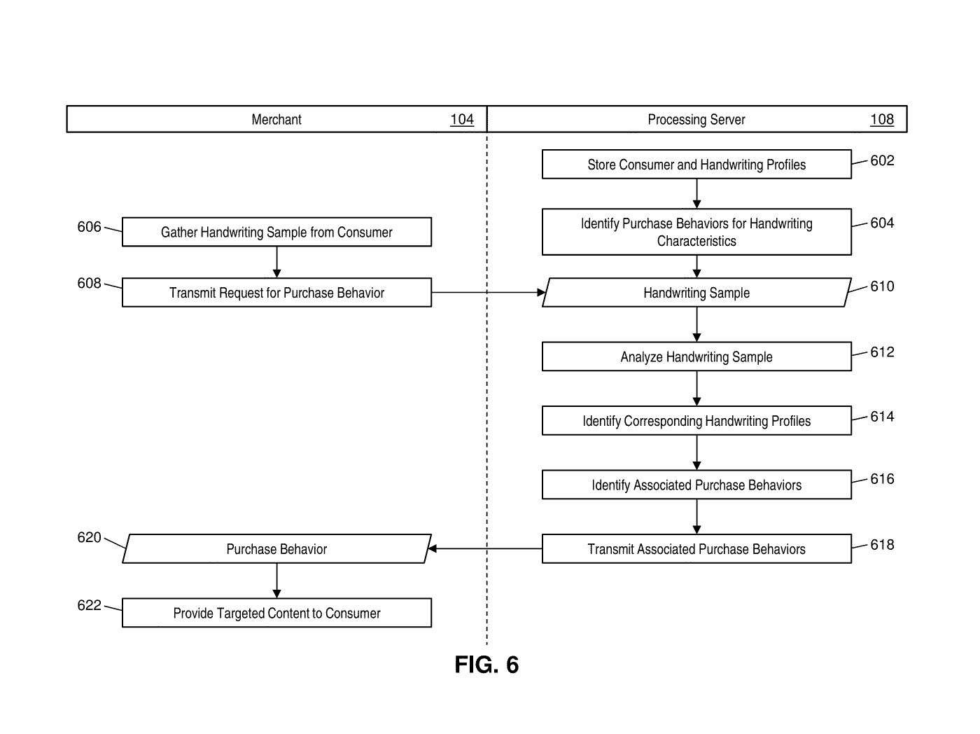

FIG. 6 illustrates a process for identifying purchase behaviors associated with handwriting characteristics of a provided handwriting sample.

In step 602, the processing unit 204 of the processing server 108 may store consumer profiles 208 in the profile database 112 and handwriting profiles 212 in the handwriting database 210. Each consumer profile 208 may include data related to one or more consumers 102 and include a plurality of transaction data entries that include transaction data for transactions involving the related one or more consumers 102 and one or more handwriting characteristics associated with the related one or more consumers 102. Each handwriting profile 212 may include an associated handwriting characteristic.

In step 604, the processing unit 204 may identify purchase behaviors associated with each of the handwriting characteristics in the handwriting profiles 212, such as illustrated in FIG. 5 and discussed above. The processing unit 204 may store the associated purchase behaviors in the respective handwriting profiles 212 in the handwriting database 210.

In step 606, a merchant 104 may gather a handwriting sample from a consumer 102, such as via a survey, contest entry, signature slip, or other suitable method. In step 608, the merchant 104 may transmit a request for purchase behavior to the processing server 108. The request for purchase behavior may include at least the gathered handwriting sample, and may also include any other suitable data, such as criteria for a response, requested purchase behaviors, etc. In step 610, the receiving unit 202 of the processing server 108 may receive the handwriting sample included in the request for purchase behavior and any additional data.

In step 612, the processing unit 204 may analyze the handwriting sample to identify one or more handwriting characteristics. The handwriting characteristics may include, for example, writing zone preference, letter connection, word connection, decrease in letter or stroke size, increase in letter or stroke size, writing slant, letter spacing, word spacing, line spacing, margin, loop size, writing pressure, writing speed, and any other characteristic that will be apparent to persons having skill in the relevant art. In step 614, the processing unit 204 may identify handwriting profiles 212 in the handwriting database 210 that include the one or more handwriting characteristics identified from the handwriting sample analysis.

In step 616, the processing unit 204 may identify the purchase behaviors included in each of the identified handwriting profiles 212. In step 618, the transmitting unit 206 of the processing server 108 may transmit the identified purchase behaviors that are associated with the handwriting sample based on the analyzed handwriting characteristics to the merchant 104. In step 620, the merchant 104 may receive the purchase behaviors. In step 622, the merchant 104 may provide content that is targeted to the consumer 102 based on the purchase behaviors. For example, if the purchase behaviors indicate a high likelihood to purchase electronics, the merchant 104 may advertise electronics to the consumer 102.

### Exemplary Method for Linking Handwriting Data to Transaction History

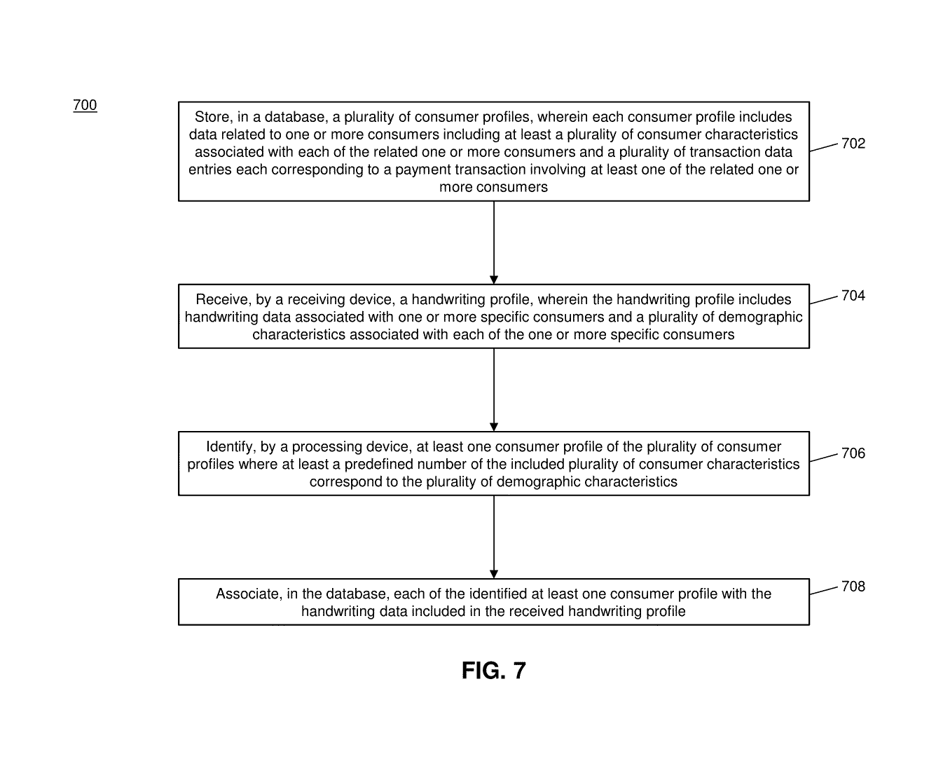

FIG. 7 illustrates a method 700 for linking consumer handwriting data to transaction history using demographic characteristics.

In step 702, a plurality of consumer profiles (e.g., the consumer profiles 208) may be stored in a database (e.g., the consumer database 112), wherein each consumer profile 208 includes data related to one or more consumers (e.g., the consumer 102) including at least a plurality of consumer characteristics associated with each of the related one or more consumers 102 and a plurality of transaction data entries (e.g., transaction data entries 212) each corresponding to a payment transaction involving at least one of the related one or more consumers 102. In some embodiments, the plurality of consumer characteristics may not be personally identifiable.

In one embodiment, the plurality of consumer characteristics may include at least one of: age, gender, income, marital status, familial status, residential status, occupation, education, zip code, postal code, street address, county, city, state, and country. In some embodiments, each transaction data entry 212 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 704, a handwriting profile may be received, by a receiving device (e.g., the receiving unit 202), wherein the handwriting profile includes handwriting data associated with one or more specific consumers 102 and a plurality of demographic characteristics associated with each of the one or more specific consumers. In one embodiment, the one or more consumers may be a community of consumers. In some embodiments, the plurality of demographic characteristics may not be personally identifiable. In one embodiment, the handwriting data may include one or more handwriting characteristics, which may include at least one of: writing zone preference, letter connection, word connection, decrease in letter or stroke size, increase in letter or stroke size, writing slant, letter spacing, word spacing, line spacing, margin, loop size, writing pressure, and writing speed.

In step 706, at least one consumer profile 208 of the plurality of consumer profiles may be identified, by a processing device (e.g., the processing unit 204), where at least a predefined number of the included plurality of consumer characteristics correspond to the plurality of demographic characteristics. In step 708, each of the identified at least one consumer profiles 208 may be associated, in the database 112, with the handwriting data included in the received handwriting profile.

### Exemplary Method for Identifying Associations Between Handwriting Characteristics and Purchase Behavior

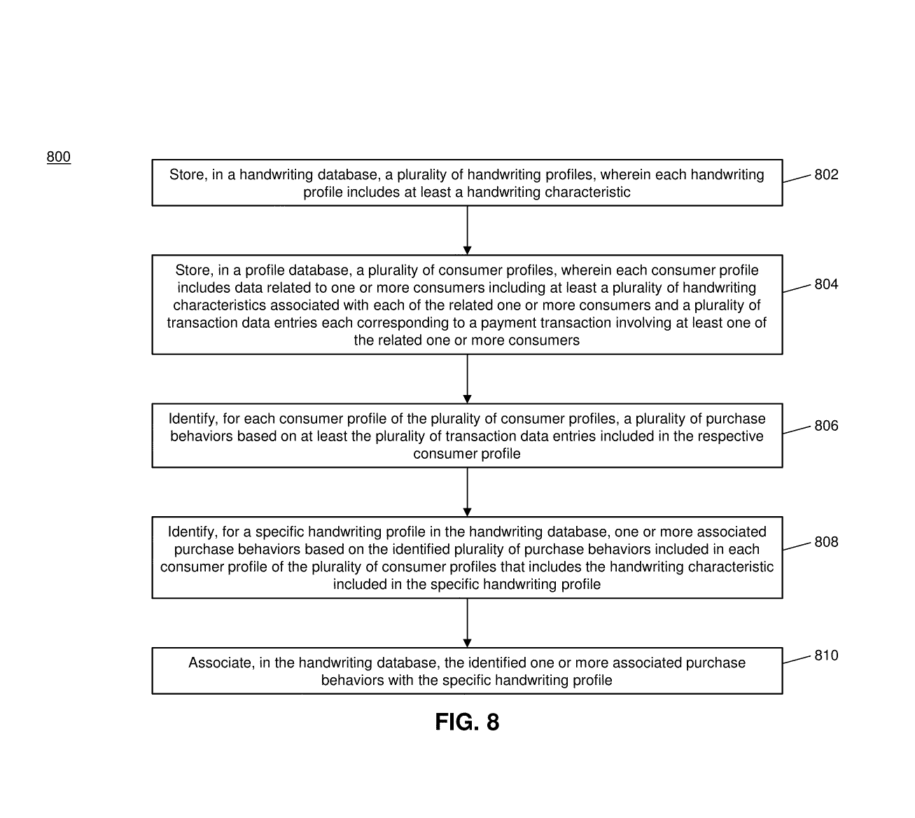

FIG. 8 illustrates a method 800 for identifying associations between handwriting characteristics and purchase behavior based on consumer transaction data and handwriting data.

In step 802, a plurality of handwriting profiles (e.g., handwriting profiles 212) may be stored in a handwriting database (e.g., the handwriting database 210), wherein each handwriting profile 212 includes at least a handwriting characteristic. In one embodiment, the handwriting characteristic may be at least one of: writing zone preference, letter connection, word connection, decrease in letter or stroke size, increase in letter or stroke size, writing slant, letter spacing, word spacing, line spacing, margin, loop size, writing pressure, and writing speed.

In step 804, a plurality of consumer profiles (e.g., consumer profiles 208) may be stored in a profile database (e.g., the profile database 112), wherein each consumer profile 208 includes data related to one or more consumers (e.g., consumers 102) including at least a plurality of handwriting characteristics associated with each of the related one or more consumers 102 and a plurality of transaction data entries each corresponding to a payment transaction involving at least one of the related one or more consumers 102.

In step 806, a plurality of purchase behaviors may be identified for each consumer profile 208 of the plurality of consumer profiles based on at least the plurality of transaction data entries included in the respective consumer profile 208. In one embodiment, the plurality of purchase behaviors may include spending behavior for one or more categories of at least one of: merchants, merchant industries, products, product categories, and manufacturers.

In step 808, one or more associated purchase behaviors may be identified for a specific handwriting profile 212 in the handwriting database 210 based on the identified plurality of purchase behaviors included in each consumer profile 208 of the plurality of consumer profiles that include the handwriting characteristic included in the specific handwriting profile 212. In step 810, the identified one or more associated purchase behaviors may be associated in the handwriting database 210 with the specific handwriting profile 212.

In one embodiment, the method 800 may further include: receiving, by a receiving device (e.g., the receiving unit 202), a purchase behavior request, wherein the purchase behavior request includes at least the handwriting characteristic included in the specific handwriting profile; identifying, in the handwriting database 210, the specific handwriting profile 212 based on the handwriting characteristic included in the received purchase behavior request; and transmitting, by a transmitting device (e.g., the transmitting unit 206), the identified one or more associated purchase behaviors.

### Exemplary Method for Identifying Purchase Behavior Using Handwriting Characteristics

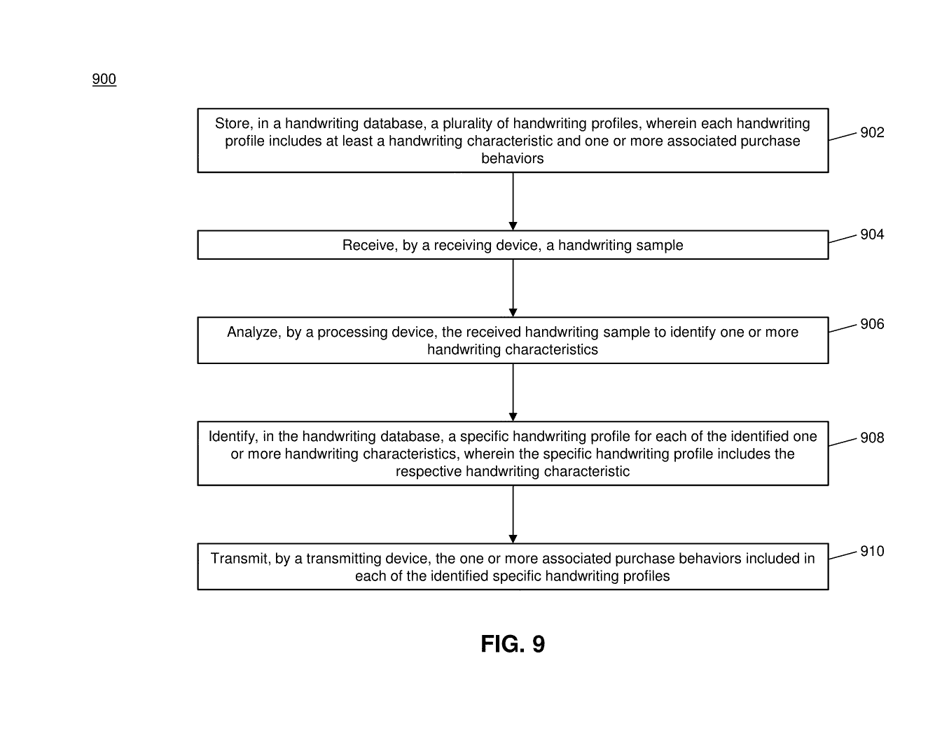

FIG. 9 illustrates a method 900 for identifying purchase behavior based on handwriting characteristics analyzed from a handwriting sample.

In step 902, a plurality of handwriting profiles (e.g., handwriting profiles 212) may be stored in a handwriting database (e.g., the handwriting database 210), wherein each handwriting profile 212 includes at least a handwriting characteristic and one or more associated purchase behaviors. In some embodiments, the purchase behaviors may include spending behavior for one or more categories of at least one of: merchants, merchant industries, products, product categories, and manufacturers. In step 904, a handwriting sample may be received by a receiving device (e.g., the receiving unit 202).

In step 906, the received handwriting sample may be analyzed by a processing device (e.g., the processing unit 204) to identify one or more handwriting characteristics. In one embodiment, the handwriting characteristics may include at least one of: writing zone preference, letter connection, word connection, decrease in letter or stroke size, increase in letter or stroke size, writing slant, letter spacing, word spacing, line spacing, margin, loop size, writing pressure, and writing speed. In step 908, a specific handwriting profile 212 may be identified in the handwriting database 210 for each of the identified one or more handwriting characteristics, wherein the specific handwriting profile 212 includes the respective handwriting characteristic.

In step 910, a transmitting device (e.g., the transmitting unit 206) may transmit the one or more associated purchase behaviors included in each of the identified specific handwriting profiles 212. In one embodiment, each handwriting profile 212 may further include one or more associated consumer characteristics, and the transmission may include the one or more associated consumer characteristics included in each of the identified specific handwriting profiles 212.

### Computer System Architecture

FIG. 10 illustrates a computer system 1000 in which embodiments of the present disclosure, or portions thereof, may be implemented as computer-readable code. For example, the processing server 108 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 6-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communications infrastructure 1006, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (HDMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 3 and 6-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for linking handwriting data to transaction history, associating handwriting data with purchase behaviors, and identifying purchase behaviors based on handwriting data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A system for linking handwriting data to transaction history, comprising:
a database configured to store a plurality of consumer profiles, wherein each consumer profile includes data related to one or more consumers including at least a plurality of consumer characteristics associated with each of the related one or more consumers and a plurality of transaction data entries each corresponding to a payment transaction involving at least one of the related one or more consumers;
a receiving device configured to receive a handwriting profile, wherein the handwriting profile includes handwriting data associated with one or more specific consumers and a plurality of demographic characteristics associated with each of the one or more specific consumers; and
a processing device configured to
identify at least one consumer profile of the plurality of consumer profiles where at least a predefined number of the included plurality of consumer characteristics correspond to the plurality of demographic characteristics, and
associate, in the database, each of the identified at least one consumer profile with the handwriting data included in the received handwriting profile.

2. The system of claim 1, wherein the plurality of consumer characteristics includes at least one of: age, gender, income, marital status, familial status, residential status, occupation, education, zip code, postal code, street address, county, city, state, and country.

3. The system of claim 1, wherein the plurality of consumer characteristics and demographic characteristics are not personally identifiable.

4. The system of claim 1, wherein the one or more consumers related to each consumer profile is a microsegment of consumers.

5. A system for identifying associations between handwriting characteristics and purchase behavior, comprising:
a handwriting database configured to store a plurality of handwriting profiles, wherein each handwriting profile includes at least a handwriting characteristic;
a profile database configured to store a plurality of consumer profiles, wherein each consumer profile includes data related to one or more consumers including at least a plurality of handwriting characteristics associated with each of the related one or more consumers and a plurality of transaction data entries each corresponding to a payment transaction involving at least one of the related one or more consumers; and
a processing device configured to
identify, for each consumer profile of the plurality of consumer profiles, a plurality of purchase behaviors based on at least the plurality of transaction data entries included in the respective consumer profile,
identify, for a specific handwriting profile in the handwriting database, one or more associated purchase behaviors based on the identified plurality of purchase behaviors included in each consumer profile of the plurality of consumer profiles that includes the handwriting characteristic included in the specific handwriting profile, and
associate, in the handwriting database, the identified one or more associated purchase behaviors with the specific handwriting profile.

6. The system of claim 5, further comprising:
a transmitting device; and
a receiving device configured to receive a purchase behavior request, wherein the purchase behavior request includes at least the handwriting characteristic included in the specific handwriting profile, wherein
the processing device is further configured to identify, in the handwriting database, the specific handwriting profile based on the handwriting characteristic included in the received purchase behavior request, and
the transmitting device is configured to transmit the identified one or more associated purchase behaviors.

7. The system of claim 5, wherein the handwriting characteristic is at least one of: writing zone preference, letter connection, word connection, decrease in letter or stroke size, increase in letter or stroke size, writing slant, letter spacing, word spacing, line spacing, margin, loop size, writing pressure, and writing speed.

8. The system of claim 5, wherein the plurality of purchase behaviors includes spending behavior for one or more categories of at least one of: merchants, merchant industries, products, product categories, and manufacturers.

9. A system for identifying purchase behavior using handwriting characteristics, comprising:
a handwriting database configured to store a plurality of handwriting profiles, wherein each handwriting profile includes at least a handwriting characteristic and one or more associated purchase behaviors;
a receiving device configured to receive a handwriting sample;
a processing device configured to
analyze the received handwriting sample to identify one or more handwriting characteristics, and
identify, in the handwriting database, a specific handwriting profile for each of the identified one or more handwriting characteristics, wherein the specific handwriting profile includes the respective handwriting characteristic; and
a transmitting device configured to transmit the one or more associated purchase behaviors included in each of the identified specific handwriting profiles.

10. The system of claim 9, wherein the one or more handwriting characteristics includes at least one of: writing zone preference, letter connection, word connection, decrease in letter or stroke size, increase in letter or stroke size, writing slant, letter spacing, word spacing, line spacing, margin, loop size, writing pressure, and writing speed.

11. The system of claim 9, wherein the plurality of purchase behaviors includes spending behavior for one or more categories of at least one of: merchants, merchant industries, products, product categories, and manufacturers.

12. The system of claim 9, wherein
each handwriting profile further includes one or more associated consumer characteristics, and
transmitting the one or more associated purchase behaviors included in each of the identified specific handwriting profiles includes transmitting the one or more associated consumer characteristics included in each of the identified specific handwriting profiles.
